(19) United States
(12) Patent Application Publication
(10) Pub. No.: US 2016/0114990 A1
(43) Pub. Date: Apr. 28, 2016

(54) Portable hand rail system and apparatus

(71) Applicant: James Kynard, Rio Rancho, NM (US)

(72) Inventor: James Kynard, Rio Rancho, NM (US)

(21) Appl. No.: 14/756,850

(22) Filed: Oct. 21, 2015

Related U.S. Application Data
(60) Provisional application No. 62/122,575, filed on Oct. 24, 2014.

(51) Int. Cl. B65G 69/28

(52) U.S. Cl. CPC B65G 69/2876

(57) ABSTRACT

The present invention is generally directed to a portable and stable hand rail for a delivery vehicle's ramp railings. In one embodiment, at least two removable vertical posts are interconnected by a flexible but taut safety net. The posts are installed to be vertical to, and with respect to, the ramp's horizontal surface, so that the posts soundly and securely attach, removably couple or removably connect to the delivery ramp side railings by the one or more clamp systems. The posts are placed sufficiently apart from one another on the ramp's railing in order to provide sufficient strength to the interconnected safety net to prevent a human from falling from the ramp. One or more attachment systems (such as hooks, for example) on the flexible safety net can further be securely attached to the ramp railing for further strength of the overall system.

### CLAIM OF PRIORITY

The present invention claims the benefit and priority of U.S. Provisional Patent Application No. 62/122,575 filed on Oct. 24, 2014.

### FIELD OF INVENTION

The present invention is generally directed to a portable hand rail, and may be particularly suited for use with and on a delivery vehicle's loading ramp.

### BACKGROUND OF THE INVENTION

It is well known in the art of delivery or transportation systems that many delivery vehicles use loading/unloading ramps located on the rear of the vehicle, which are sloped passageways, with one end being in travel communication with the cargo inside the delivery vehicle and at a much higher elevational plane, and the other end of the ramp being placed on the ground on a separate (typically much lower) elevational plane. Such ramps are useful, in that they allow delivery workers to load and/or unload cargo to and from the delivery vehicle.

However, it is also a well known problem that such ramps can be unsafe, especially during inclement weather (e.g., rain, snow, ice. drizzle, high winds, etc.), because without an adequate rail system to protect the delivery worker, the delivery worker has a high chance of slipping on the ramp, or even falling off the ramp due to the inclement weather, resulting in severe injury and/or death.

There are numerous rail systems and rail guards disclosed in the prior art, however, the prior art disclosures are typically cumbersome to install and use, are otherwise complicated and typically include a significant amount of mechanical structures which are expensive and add significant weight of the overall system. Some systems are also motorized, which again leads to more cost and more weight. Some systems are set up as fence systems, having multiple rigid tubes to define the fence, which again, leads to more cost and weight. As such, while such prior art systems may work to provide some form of safety to the delivery worker, such systems are heavy, complicated, difficult to use and expensive.

The proposed invention is a non-motorized portable hand rail system or apparatus, which also equates to a portable guard rail system or apparatus, for use on a delivery vehicle's loading and unloading ramp or similar pathway. The proposed railing is connectably removable from a ramp typically found on a delivery truck. The present invention is intended to withstand any stress, strain and tension should a safety worker slip and/or fall on the ramp, thereby preventing the worker from falling off the ramp and severely injuring themselves. The present invention could also be used as a railing system for loading docks, truck docks, platforms and other work and loading platforms to provide worker safety.

It is therefore an exemplary feature of the present invention to provide a novel method, system or apparatus for a non-motorized portable hand rail to provide safety to the delivery personnel while they either load or unload cargo from the delivery vehicle.

### SUMMARY OF THE INVENTION

The following summary of the invention is provided to facilitate an understanding of some of the innovative features unique to the present invention, and is not intended to be a full description of variations that may be apparent to those of skill in the art. A full appreciation of the various aspects of the invention can be gained from the entire specification, claims, drawings, and abstract taken as a whole.

The present invention is generally directed to a portable and stable hand rail having, in one embodiment, at least two removable vertical posts (or, structures/bars) which are interconnected therebetween by a flexible safety net, the overall structure designed to withstand any stress or strain from a human body that may be in a position to fall off of a ramp structure. The bars are installed to be vertical to, and with respect to, the ramp's horizontal surface, so that the bars soundly and securely attach, removably couple or removably connect to the delivery ramp side railings by the one or more clamp systems. One or more clips on the flexible safety net can further be securely attached, removably couple or removably connect to the ramp railing for further strength of the overall system sufficient to prevent a delivery worker from falling off the ramp.

This disclosure describes numerous specific details that include specific structures and elements, their particular arrangement, and their particular functions in order to provide a thorough understanding of the present invention. One skilled in the art will appreciate that one may practice the present invention without the specific details.

The novel features of the present invention will become apparent to those of skill in the art upon examination of the following detailed description of the preferred embodiment or can be learned by practice of the present invention. It should be understood, however, that the detailed description of the preferred embodiment and the specific examples presented, while indicating certain embodiments of the present invention, are provided for illustration purposes only because various changes and modifications within the spirit and scope of the invention will become apparent to those of skill in the art from the detailed description, drawings and claims that follow.

### BRIEF DESCRIPTION OF THE DRAWINGS

The accompanying figures further illustrate the present invention and, together with the detailed description of the preferred embodiment, assists to explain the general principles according to the present invention.

FIG. 1 illustrates a side plan view of one embodiment of the present invention;

FIG. 2 illustrates a front side plan view of a representative post system used in the present invention;

FIG. 3 illustrates a rear side plan view of the representative post system illustrated in FIG. 2;

FIG. 4 illustrates a left side plan view of the representative post system illustrated in FIG. 2;

FIG. 5 illustrates a right side plan view of the representative post system illustrated in FIG. 2;

FIG. 6 illustrates a top side plan view of the representative post system illustrated in FIG. 2;

FIG. 7 illustrates a bottom side plan view of the representative post system illustrated in FIG. 2;

FIG. 8 illustrates a side perspective view of the representative post system illustrated in FIG. 2;

FIG. 9 illustrates the present invention in operation through a side plan view, as it is attached to one side of a delivery vehicle's loading ramp rail or railing system; and

FIG. 10 illustrates the present invention in operation through a side perspective view, as it is attached to one side of a delivery vehicle's loading ramp rails or railing system.

Additional aspects of the present invention will become evident upon reviewing the non-limiting embodiments described in the specification and the claims taken in conjunction with the accompanying figures, wherein like reference numerals denote like elements.

### DETAILED DESCRIPTION OF THE PREFERRED EMBODIMENT

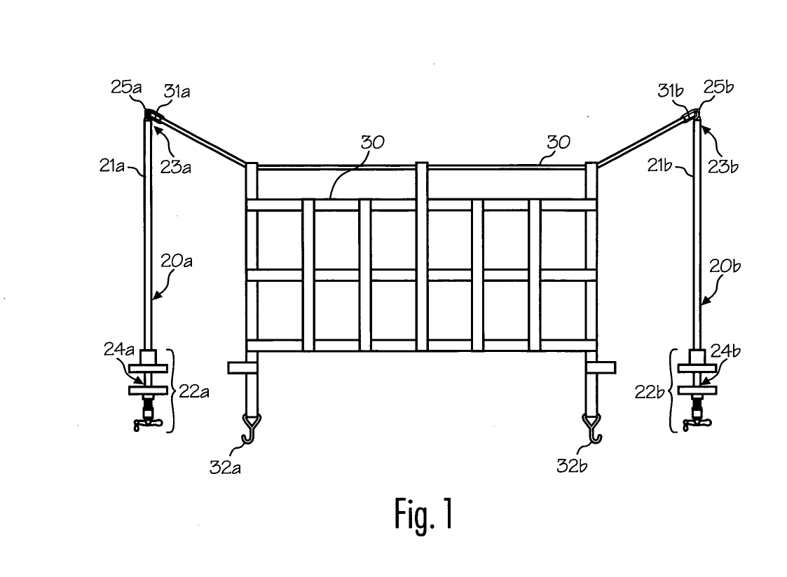

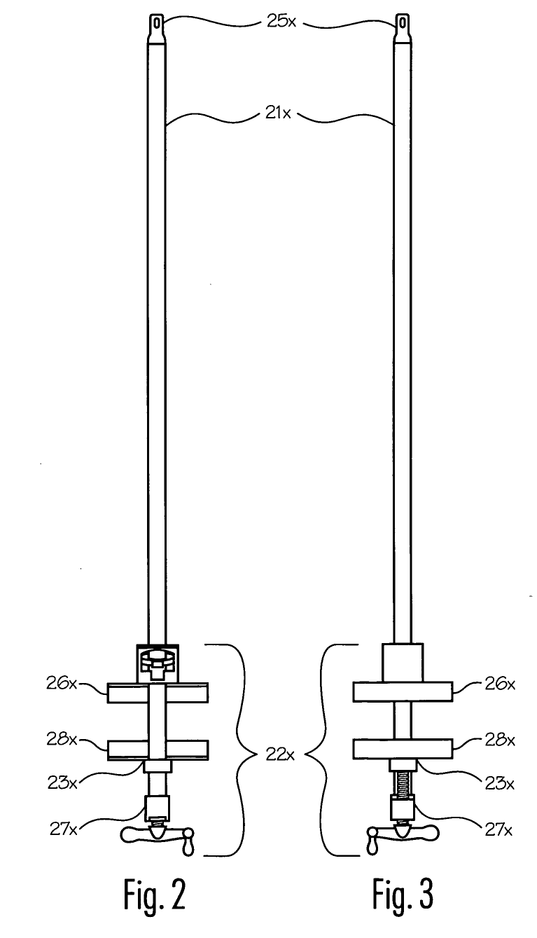

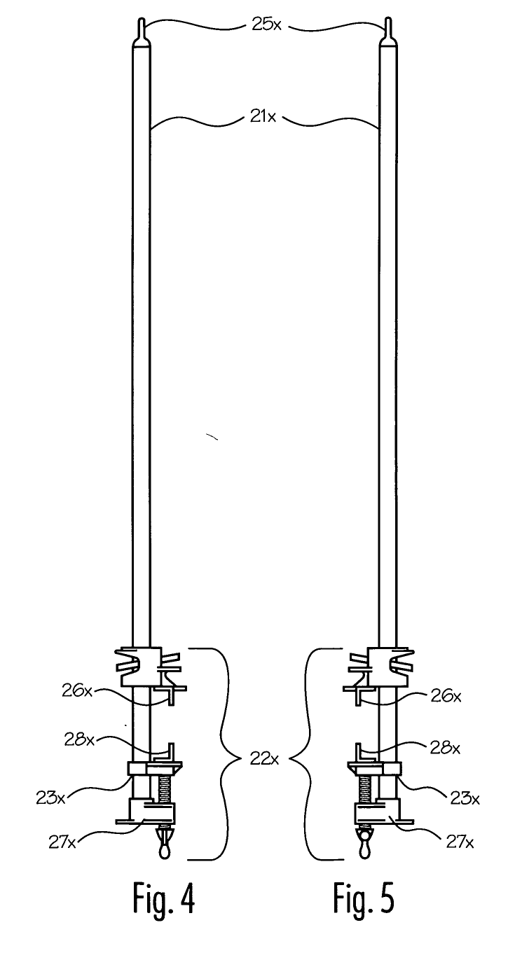

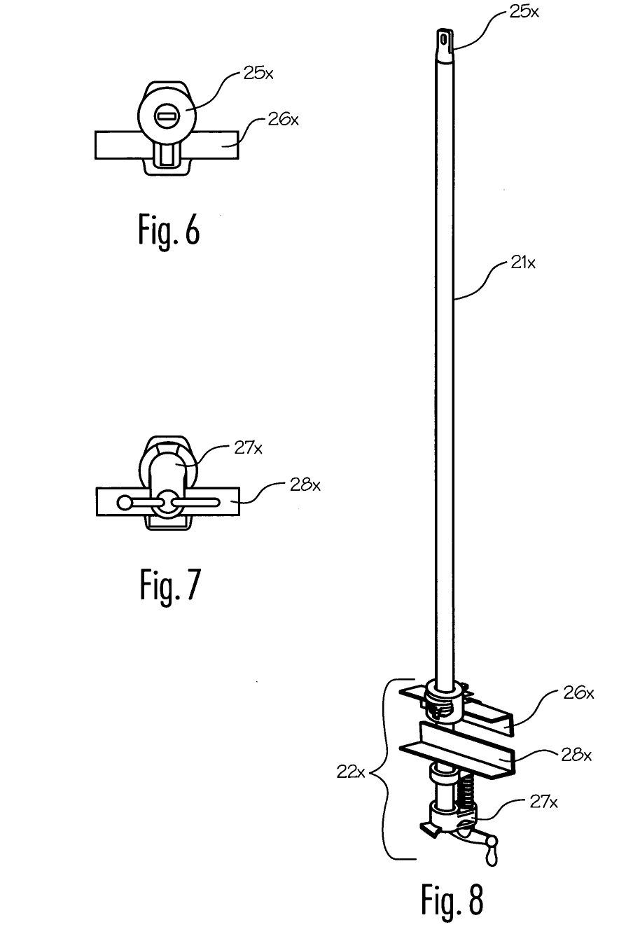

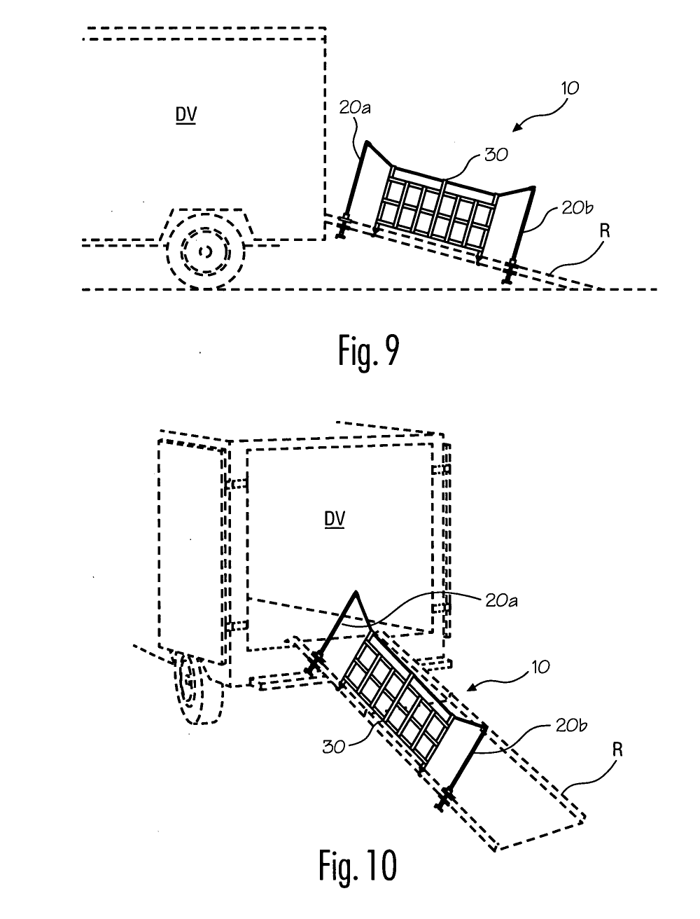

The present invention is a portable hand rail system or apparatus 10 as shown in FIG. 1 for a ramp having side railings (as seen in FIGS. 9-10). As seen in FIGS. 2-8, the present invention includes at least two vertical post systems 20ₓ (where x=a, b, c, d., etc.), where each post system 20ₓ is an elongated bar or similar structure with each post system 20ₓ having at least one clamp system 22ₓ on a bottom end of each post system, and having at least one eyelet coupler 23ₓ on a top end of each post system 20ₓ, with each post system 20ₓ being interconnected tautly to another post system 20ₓ therebetween by a flexible safety net 30 (as seen in FIG. 1), the flexible safety net 30 and each clamp system 22ₓ adapted to securely attach, removably couple or removably connect to the ramp's railings R on a delivery vehicle DV (as seen, for example, in FIGS. 9-10).

While reference is made to the present invention's use of at least two vertical post systems 20ₓ, the structure of each post system 20ₓ is substantially if not exactly the same. As such, a representative post system 20ₓ is illustrated in FIGS. 2-8 and described as follows. Each post system 20ₓ is an elongated vertical structure or bar 21a, 22a of predefined height having a top end 23a, 23b and a bottom end 24a, 24b (as seen in FIG. 1). In a preferred embodiment, an eyelet coupler 25a is formed on, or otherwise attached to, the top end 23a and is adapted to securely receive and retain a first end strap 31a of safety net 30. Similarly, an eyelet coupler 25b is formed on, or otherwise attached to, the top end 23b and is adapted to securely receive and retain a second end strap 31b of safety net 30. While in the preferred embodiment, an eyelet connector is disclosed to securely receive and retain some portion of the safety net, those of skill in the art will realize that any type of connecting structure can replace the eyelet connector as long as the connecting structure similarly securely receives and retains some portion of the safety net, so that any connecting structure remains within the scope of this invention

Continuing to review FIGS. 2-8, each post system 20ₓ further preferably includes a clamp system 22ₓ adapted to securely attach, removably couple or removably connect to the ramp's railings. A preferable embodiment of a representative adjustable clamp system 22ₓ is shown in FIGS. 2-8, and includes a fixed clamp head 26ₓ which is coupled to, or otherwise formed on, the elongated bar 21ₓ close to the bar's bottom end 23ₓ. At the bar's bottom end 23ₓ, in a preferred embodiment, a press screw mechanism 27ₓ is attached to and engages a moveable clamp head 28ₓ so that when the press screw mechanism 27ₓ is engaged by rotation clockwise, moveable clamp head 28ₓ moves closer to, and in registration with, fixed clamp head 26ₓ so that adjustable clamp system 22ₓ closes together in order to securely clamp or couple the post system 20ₓ to a delivery vehicle ramp's railing R (as shown in FIGS. 9-10). Conversely, if the press screw mechanism 27ₓ is rotated counter-clockwise, the moveable clamp head 28, moves away from fixed clamp head 26ₓ so that adjustable clamp system 22,, opens in order to open the clamp system 22ₓ to uncouple and remove the post system 20ₓ from a delivery vehicle ramp's railing R. Of course, those of skill in the art will now realize that while this particular disclosure is of a preferred clamp system, any other type of clamp system which is adapted to securely attach, removably couple or removably connect to the ramp's railings are within the spirit and scope of this invention.

The present invention 10 further includes at least one safety net 30 having at least a first end strap 31a, a second end strap 31b and at least a first attachment system 32ₓ as seen in FIG. 1. As noted previously, eyelet coupler 25a is adapted to securely receive and retain the first end strap 31a of safety net 30, while eyelet coupler 25b is adapted to securely receive and retain a second end strap 31b of safety net 30 when the present invention is used on a loading ramp R. At least first attachment system 32ₓ (which could be a hook attachment, for example) is adapted to securely attach, removably couple or removably connect to the ramp's railings, and allows further structural stability and strength to the present invention.

Those of skill in the art will immediately recognize that the predefined height of the posts and/or safety net can vary depending upon the application, so that (for example) in one embodiment, the posts and/or safety net may have adjustable height (increasing and/or decreasing) to fit the application's specification as needed.

In operation and when the ramp is ready for use, each post system 20ₓ is coupled to the ramp railing R via the clamp system 22ₓ at a distance from each other sufficient to allow the flexible net 30 to be taut, tightly stretched or pulled tight (and otherwise without significant slack) when the flexible net 30 is attached to the post systems 20ₓ at the first end strap 31a and second end strap 31b (as seen in FIG. 1). Then, the at least first attachment system 32ₓ is also attached to the ramp's railing R to provide further stability and strength of the present invention. To disengage the portable hand rail 10, the clamp system 22ₓ is disengaged from the ramp's railing R, as is the at least first attachment system 32ₓ so that the hand rail 10 is then uncoupled from the ramp. When not in use, the present invention's post systems 20x and flexible safety net 30 may easily be placed inside of the cab of the delivery vehicle for storage.

Additional optional elements are also contemplated, as disclosed and discussed throughout this invention. In one embodiment, all of the disclosed components may be assembled as a complete system, or as an apparatus.

Several advantages arise from use of the present invention. For example, because the present invention can minimally be described as three main components (the at least two rigid posts which are interconnected therebetween by the lightweight flexible safety net), it is simple to install and remove from the ramp (e.g., removably connectable). Moreover, it is lightweight, and easily storable on the delivery vehicle. The post system can be formed of any conventional lightweight material (such as plastic) if needed, and will result is less manufacturing cost. Plus, the present invention can be used over and over again, without disrupting the delivery worker's performance, while still providing safety to the delivery worker. Finally, the safety net 30 may be a convention, off-the-shelf, safety net, which results in lower overall manufacturing costs.

Those of skill in the art will soon realize the numerous advantages found when utilizing the present invention. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “ critical”.

Other variations and modifications of the present invention will be apparent to those of ordinary skill in the art, and it is the intent of the appended claims that such variations and modifications be covered. The particular values and configurations discussed above can be varied, are cited to illustrate representative embodiments of the present invention and are not intended to limit the scope of the invention. It is contemplated that the use of the present invention can involve components having different characteristics and structures so long as the invention's basic principles are followed.

I claim:

1. A portable hand rail system for a ramp having side railings, the system comprising at least two post systems, each post system having at least one adjustable clamp system on a bottom end and having at least one eyelet coupler on a top end, each post system being interconnected tautly therebetween with a flexible safety net coupled to each eyelet coupler, the flexible safety net and each clamp system being adapted to removably connect to the ramp's railings.

2. The system of claim 1, each safety net further comprising at least a first end strap, a second end strap and at least a first attachment system, the at least first attachment system being adapted to securely attach, removably couple or removably connect to the ramp's railings provide structural stability and strength to the hand rail system.

3. The system of claim 2 wherein each post system is an elongated bar.

4. The system of claim 3 wherein each flexible safety net and each adjustable clamp system are adapted to securely attach, removably couple or removably connect to the ramp's side railings.

5. The system of claim 4 wherein each eyelet coupler is adapted to securely receive and retain at least a first end strap of the safety net.

6. The system of claim 5 wherein each eyelet coupler is adapted to securely receive and retain at least a second end strap of the safety net.

7. The system of claim 6, the adjustable clamp system further comprising a fixed clamp head which is coupled to the elongated bar close to the bar's bottom end, and a press screw mechanism, the press screw mechanism being located at the bar's bottom end, the press screw mechanism further being attached to a moveable clamp head so that when the press screw mechanism is engaged by rotation clockwise, moveable clamp head moves closer to, and in registration with, fixed clamp head so that adjustable clamp system closes together in order to securely clamp or couple the post system to a delivery vehicle ramp's railing.

8. The system of claim 7 wherein as the press screw mechanism is rotated counter-clockwise, the moveable clamp head moves away from fixed clamp head so that adjustable clamp system opens in order to open the clamp system to uncouple and remove the post system from a delivery vehicle ramp's railing.

9. A portable hand rail for a cargo ramp on a delivery vehicle, the ramp having side railings, the hand rail comprising a plurality of post systems of predefined height, each post system having at least one clamp system on a bottom end and having at least one eyelet coupler on a top end, each post system being interconnected tautly therebetween with one or more flexible safety nets, each flexible safety net and each clamp system being adapted to removably connect to the ramp's railings.

10. The hand rail of claim 9, wherein each post system is an elongated bar

11. The hand rail of claim 10 wherein the predefined height is adjustable.

12. The hand rail of claim 11 wherein each flexible safety net and each adjustable clamp system are adapted to securely attach, removably couple or removably connect to the ramp's side railings.

13. The hand rail of claim 12 wherein each eyelet coupler is adapted to securely receive and retain at least a first end strap of the safety net.

14. The hand rail of claim 13 wherein each eyelet coupler is adapted to securely receive and retain at least a second end strap of the safety net.

15. A hand rail of claim 14, the adjustable clamp system further comprising a fixed clamp head which is coupled to the elongated bar close to the bar's bottom end, and a press screw mechanism, the press screw mechanism being located at the bar's bottom end, the press screw mechanism further being attached to a moveable clamp head so that when the press screw mechanism is engaged by rotation clockwise, moveable clamp head moves closer to, and in registration with, fixed clamp head so that adjustable clamp system closes together in order to securely clamp or couple the post system to a delivery vehicle ramp's railing, and wherein as the press screw mechanism is rotated counter-clockwise, the moveable clamp head moves away from fixed clamp head so that adjustable clamp system opens in order to open the clamp system to uncouple and remove the post system from a delivery vehicle ramp's railing.

16. A portable hand rail for a ramp having side railings, the hand rail comprising a plurality of post systems of adjustable height, each post system having at least one adjustable clamp system on a bottom end and having at least one connecting structure on a top end, each post system being interconnected tautly therebetween with one or more flexible safety nets, each flexible safety net and each clamp system being adapted to removably connect to the ramp's railings.

17. The hand rail of claim 15 wherein each connecting structure is adapted to securely receive and retain some portion of the safety net.

18. The hand rail of claim 17 wherein each flexible safety net and each adjustable clamp system are adapted to securely attach, removably couple or removably connect to the ramp's side railings.

19. The hand rail of claim 18, the adjustable clamp system further comprising a fixed clamp head which is coupled to the elongated bar close to the bar's bottom end, and a press screw mechanism, the press screw mechanism being located at the bar's bottom end, the press screw mechanism further being attached to a moveable clamp head so that when the press screw mechanism is engaged by rotation clockwise, moveable clamp head moves closer to, and in registration with, fixed clamp head so that adjustable clamp system closes together in order to securely clamp or couple the post system to a delivery vehicle ramp's railing.

20. The system of claim 19 wherein as the press screw mechanism is rotated counter-clockwise, the moveable clamp head moves away from fixed clamp head so that adjustable clamp system opens in order to open the clamp system to uncouple and remove the post system from a delivery vehicle ramp's railing.
